(19) United States
(12) Patent Application Publication
(10) Pub. No.: US 2009/0028477 A1
(43) Pub. Date: Jan. 29, 2009

(54) Bearing Arrangement for a Creel

(76) Inventors: Heinz Fink, Krefeld (DE); Thomas Schicks, Krefeld (DE)

Correspondence Address: K&L Gates LLP, 214 N. TRYON STREET, HEARST TOWER, 47TH FLOOR, CHARLOTTE, NC, 28202, US

(21) Appl. No.: 11/665,094

(22) PCT Filed: Aug. 6, 2005
(86) PCT No.: PCT/EP2005/008564

§ 371 Date: Apr. 11, 2007

(30) Foreign Application Priority Data
Oct. 11, 2004 (DE) 10 2004 049 727.3

(51) Int. Cl. F16C 33/08

(52) U.S. Cl. 384/129

(57) ABSTRACT

Bearing arrangement for a creel for holding a wind-on bobbin for winding on an elongate textile strand, wherein the bearing arrangement has a bushing, which surrounds a pin, wherein alternatively either the bushing or the pin is non-rotatably connected to the creel, and wherein the pin and bushing can be rotated relative to one another, so the creel is pivotable. According to the invention, the bushing (15, 15A) is fixed by means of a press ring (16, 16A) positioned with a press fit on the bushing (15, 15A).

### CROSS-REFERENCES TO RELATED APPLICATIONS

This application claims the benefit of German patent application 10 2004 049 727.3, filed Oct. 11, 2004, herein incorporated by reference.

### BACKGROUND OF THE INVENTION

The invention relates to a bearing arrangement for a creel for holding a windon bobbin for winding on a textile strip or thread.

It is conventional to wind the finished winding-on thread onto a bobbin in a cross winding or parallel winding on spinning, winding or twisting machines. For this purpose, the bobbins are held in creels and made to rotate by friction drive rollers, for example. The type of winding can be produced, in each case, by controlled cooperation of the rotational speed of the bobbin and, for example, a thread guide which can be moved back and forth in the axial direction of the friction drive roller. The creels are pivotable and, in the course of the winding-on process, the so-called bobbin travel, carry out a continuous pivoting movement, as a function of the increasing bobbin diameter. Creels of this type are shown, for example, in German Patent Publication DE 198 17 315 C or DE 100 45 909 A1.

In addition to ensuring perfect functioning, the price of the machines during distribution plays an important part. The production costs therefore have to kept low or even reduced.

### SUMMARY OF THE INVENTION

The object of the invention is to provide a simple, economical design of the bearing arrangement for creels.

This object is achieved by a bearing arrangement for a creel for holding a windon bobbin for winding on a strip-shaped or thread-shaped textile item, wherein the bearing arrangement has a bushing, which surrounds a pin, wherein alternatively either the bushing or the pin is non-rotatably connected to the creel, and wherein the pin and bushing can be rotated relative to one another, so the creel is pivotable. In accordance with the invention, the bushing is fixed by means of a press ring.

Advantageous embodiments of the invention are additionally disclosed.

A bearing arrangement, in which the bushing is fixed by means of a press ring can be produced easily and with little outlay. The fixing of the bushing by means of the press ring brings about a dimensionally stable and secure holding of the bushing. A configuration of the press ring wherein the ratio of the external diameter of the press ring to the internal diameter of the press ring is between 1.2 and 1.7, preferably 1.4, is especially advantageous. The angle position of the fixed bushing is constantly maintained.

The bushing is preferably fixed to the bracket and the pin is non-rotatably connected to the creel. This design is particularly simple and expedient.

A configuration of the bracket with two creels, which are pivotably mounted independently of one another in a respective bushing, requires little space and allows the number of components to be kept small.

Fastening the bushing by means of a press ring arranged with a press fit on the bushing is more economical compared to soldering or welding fastenings which are otherwise conventional in such applications and has proven to be surprisingly stable. The small cost advantage per bearing arrangement, regarded in absolute terms, multiplies in spinning, winding or twisting machines with their plurality of workstations and in total contributes to low production costs.

An embodiment of the bearing arrangement according to the invention will be described below.

### BRIEF DESCRIPTION OF THE DRAWINGS

FIG. 1 shows a winding device for yarn with two creels,

FIG. 2 shows a simplified side view of the winding device of FIG. 1,

FIG. 3 shows the bearing arrangement of the creels of FIG. 1, partially in section.

### DESCRIPTION OF THE PREFERRED EMBODIMENTS

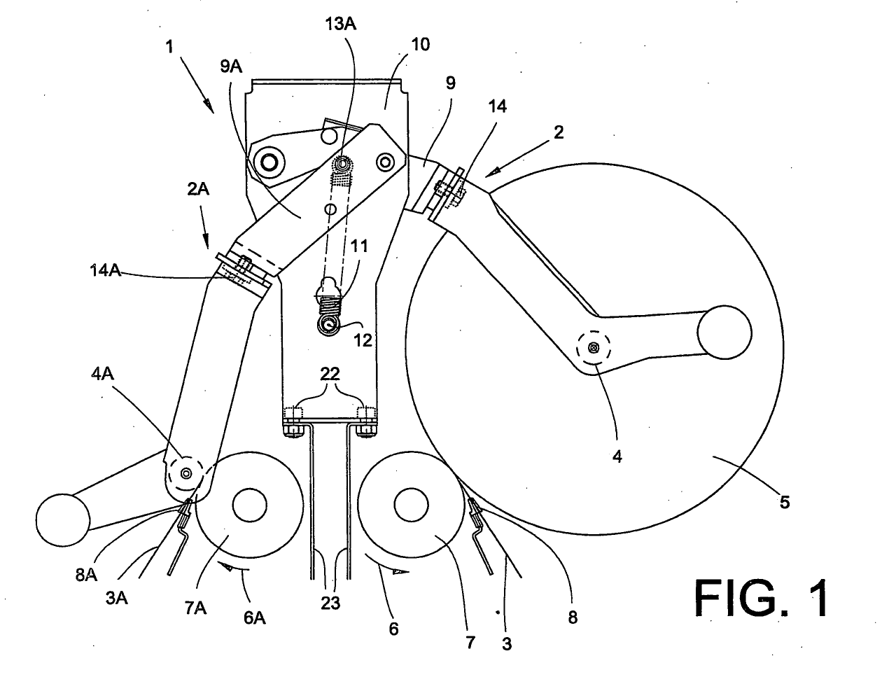

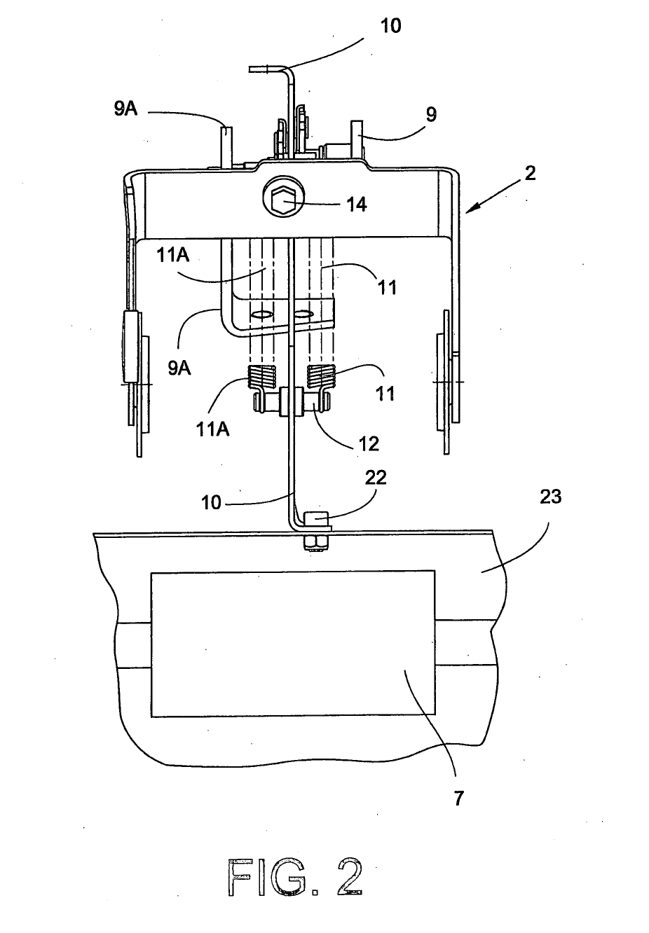

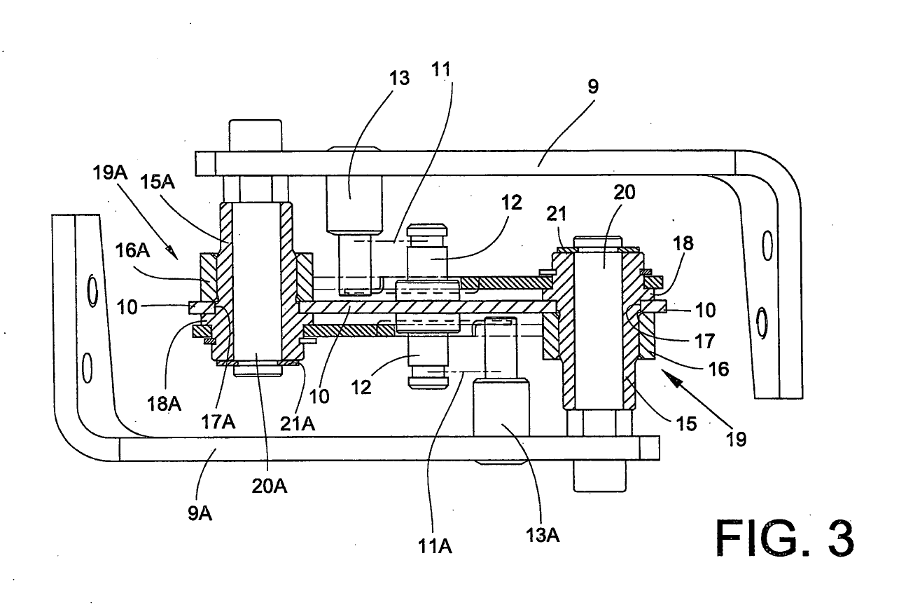

The winding device 1 for yarn shown in FIG. 1 shows two creels 2, 2A for holding the bobbin. The thread 3, 3A is in each case wound onto a bobbin tube 4, 4A. The creel 2 holds an almost full bobbin 5, while the winding process on the bobbin tube 4A, which is held by the creel 2A, is just beginning and the yarn body of the bobbin is not yet visible. The bobbin 5 or the bobbin tubes 4, 4A are in each case made to rotate by a friction drive roller 7, 7A rotating in the direction of the arrow 6, 6A. A traversing thread guide 8, 8A moves the running-on thread 3, 3A back and forth parallel to the axle of the friction drive roller 7, 7A in such a way that a cross winding is formed. The creel 2, 2A is fastened by a screw 14, 14A on a pivoting arm 9, 9A and pivotably mounted on the bracket 10 by means of this pivoting arm 9, 9A. The bracket 10 is formed from a single metal sheet. A helical spring 11, 11A, in each case, engages with the lower end on a holding pin 12 fastened to the bracket 10 and with the upper end on a clamping pin 13, 13A, as can also be seen from FIGS. 2 and 3.

The helical spring 11, 11A is partially represented in the figures in a simplified manner by dash-dot lines. The helical springs 11, 11A act as tension springs and act on the pivoting arm 9, 9A with a downwardly directed tensile force. The bushing 15, 15A is rigidly connected to the metal sheet of the bracket 10 with the aid of a press ring 16, 16A positioned with a press fit on the bushing 15, 15A.

During assembly of the bearing arrangement 19, 19A, the bushing 15, 15A is initially pushed through the bore 17, 17A in the metal sheet of the bracket 10 until the stop 18, 18A of the bushing 15, 15A rests on the metal sheet of the bracket 10. The press ring 16, 16A is then pressed with the aid of a pressing mechanism onto the bushing 15, 15A in such a way that the metal sheet of the bracket 10 is acted upon by pressure from either side between the stop 18, 18A and the press ring 16, 16A. The connection thus produced of the metal sheet of the bracket 10 with the bushing 15, 15A is very stable. A ratio of the external diameter to the internal diameter of the press ring 16, 16A of about 1.4 ensures stable support. Further support of the bushing 15, 15A is thus not required and it is sufficient that the bushing 15, 15A rests only on one metal sheet. The use of material can thereby be kept low. The clamping pin 13, 13A is rigidly connected by means of a rivet connection and the pin 20, 20A by means of a screw connection to the pivoting arm 9, 9A. If a rivet connection were also chosen for fastening the bushing 15, 15A to the metal sheet of the bracket 10, holding by means of a rivet connection at each end of the bushing 15, 15A, for example using a second bracket metal sheet would be necessary for adequate stability. The pin 20, 20A is inserted into the bushing 15, 15A during assembly and secured by a securing ring 21, 21A against release therefrom. The pin 20, 20A is rotatable in the bushing 15, 15A and therefore the creel 2, 2A is pivotable. The bracket 10 is fastened to the machine frame 23 by means of screws 22. The bracket 10 carries two creels 2, 2A, which are in each case pivotable in their own bearing arrangement 19, 19A. The fastening of the bushing 15, 15A by means of a press ring 16, 16A, which is arranged with a press fit on the bushing 15, 15A is a stable economical design of the bearing arrangement 19, 19A and ensures a secure hold and the maintenance of the orientation of the creel 2, 2A during the pivoting movement.

What is claimed is:

1. Bearing arrangement for a creel for holding a wind-on bobbin for winding on an elongate textile strand, wherein the bearing arrangement has a bushing, which surrounds a pin, wherein alternatively either the bushing or the pin is non-rotatably connected to the creel, and wherein the pin and bushing can be rotated relative to one another, so the creel is pivotable, characterized in that the bushing (15, 15A) is fixed by means of a press ring (16, 16A) positioned with a press fit on the bushing (15, 15A).

2. Bearing arrangement according to claim 1, characterized in that the bushing (15, 15A) is fixed to a bracket (10) formed from sheet metal and the pin (20, 20A) is non-rotatably connected to the creel (2, 2A).

3. Bearing arrangement according to claim 1, characterized in that, on a bracket (10), two creels (20, 20A) are pivotably mounted independently of one another in a respective bushing (15, 15A).

4. Bearing arrangement according to claim 1, characterized in that the ratio of the external diameter of the press ring (16, 16A) to the internal diameter of the press ring (16, 16A) is between 1.2 and 1.7, preferably 1.4.

5. Bearing arrangement according to claim 1, characterized in that the ratio of the external diameter of the press ring (16, 16A) to the internal diameter of the press ring (16, 16A) is about 1.4.
